(19) United States
(12) Patent Application Publication
(10) Pub. No.: US 2013/0255885 A1
(43) Pub. Date: Oct. 3, 2013

(54) ARTICLE-HANDLING MACHINE

(71) Applicant: James Carmichael, Parma (IT)

(72) Inventor: James Carmichael, Parma (IT)

(73) Assignee: SIDEL S.p.A. con Socio Unico, Parma (IT)

(21) Appl. No.: 13/992,335

(22) PCT Filed: Dec. 10, 2010
(86) PCT No.: PCT/IT2010/000496

§ 371 Date: Jun. 7, 2013

(51) Int. Cl. B65G 37/00; B65C 9/02; B65G 29/00

(52) U.S. Cl. CPC B65G 37/00; B65G 29/00; B65C 9/02
USPC 156/538; 198/608; 198/793

(57) ABSTRACT

There is disclosed a series of article-handling machines, comprising: a common first rotating element rotatable about an axis; characterized in that each article-handling machine comprises a carousel for conveying a plurality of articles along a path and a first connecting element which is angularly integral with carousel and is releasably connected to first rotating element.

### TECHNICAL FIELD

The present invention relates to a series of article-handling machines and to an article-handling machine.

### BACKGROUND ART

Typical examples of article-handling machine used in the food-product bottling industry are blowing machines, filling machines and/or labelling machines.

The above-mentioned article-handling machines are fed with article to be processed, carry out one or more operations onto said articles and output the processed articles.

More precisely, known article-handling machine comprises:
a shaft which is rotatable about a vertical axis;
a carousel which is angularly integral with the shaft and provided with a plurality of supporting elements for bottom ends of respective articles;
a wheel which is angularly integral with the shaft and provided with a plurality of bell-shaped clamping elements each movable between a raised position in which they leave free the relative articles and a lowered position in which they cooperate with top ends of respective articles;
a cam stationary relative to the shaft and adapted to interact with a roller of each clamping element for moving it between a relative raised and a relative lowered position; and
a slip-ring which electrically connects a stationary frame with a member which rotates about the vertical axis.

More precisely, articles enter the machine at an inlet station, move together with relative supporting elements along an arc-shaped path and output the machine at an outlet station.

Furthermore, the cam interacts with each roller to move the relative clamping element towards the raised position at the inlet station, to keep relative clamping element in the closed position along the arc-shaped path, and to move the relative clamping element towards the lowered position at the outlet station.

In this way, as articles move along the arc-shaped path, their bottom ends are supported by relative supporting elements and their top ends cooperate with relative bell-shaped clamping elements.

In case that the article handling machine is a labelling machine, a labelling group applies a label onto articles, as they move along the arc-shaped path.

In case that the glue applied onto labels is cold, article-handling machine also comprises a brush ring stationary relative to the shaft and adapted to wipe down the label after attachment.

In particular, the carousel and the wheel are made in one-piece with the shaft.

In other words, known article-handling machines comprise a one-piece assembly made of the shaft, the carousel and the wheel.

Final customers call for a wide range of carousel diameters and of pitches between the supporting elements. In this way, different values of the final throughput of the labelling machine may be achieved.

However, any variation in the diameter of carousel and in the pitch between the supporting elements inevitabily results in a full redesign of the whole one-piece assembly of the known labelling machine.

In the very same way, any variation in the vertical position of the clamping devices, of the carousel and of the operative group results in a full redesign and in the replacement of the whole one-piece assembly.

As a consequence, providing final customers with a wide range of labelling machines which have different throughputs is costly and results in an undesiderable proliferation of assemblies and logistics.

A need is felt within the industry to increase as far as possible the range of throughputs which may be achieved by the article-handling machine, without requiring the time-consuming and costly replacement of the whole assembly.

### DISCLOSURE OF INVENTION

It is an object of the present invention to provide a series of article-handling machines which meets the above-identified requirement.

The aforementioned object is achieved by the present invention as it relates to a series of article-handling machine as claimed in claim 1.

The present invention also relates to an article-handling machine as claimed in claim 14.

### BRIEF DESCRIPTION OF THE DRAWINGS

One preferred embodiment is hereinafter disclosed for a better understanding of the present invention, by way of non-limitative example and with reference to the accompanying drawings, in which:

FIG. 1 is a frontal perspective view of a first embodiment of an article handling machine of a series according to the present invention, with parts removed for clarity;

FIG. 2 is a frontal perspective view of the article-handling machine of FIG. 1, with parts removed for clarity;

FIGS. 3 and 4 are respectively a frontal and a rear section of the article-handling machine of FIGS. 1 and 2;

FIG. 5 is a top view of the article-handling machine of FIGS. 1 to 4; and

FIG. 6 is a schematic view of a frontal section of a second embodiment of the article-handling machine of FIGS. 1 to 5.

### BEST MODE FOR CARRYING OUT THE INVENTION

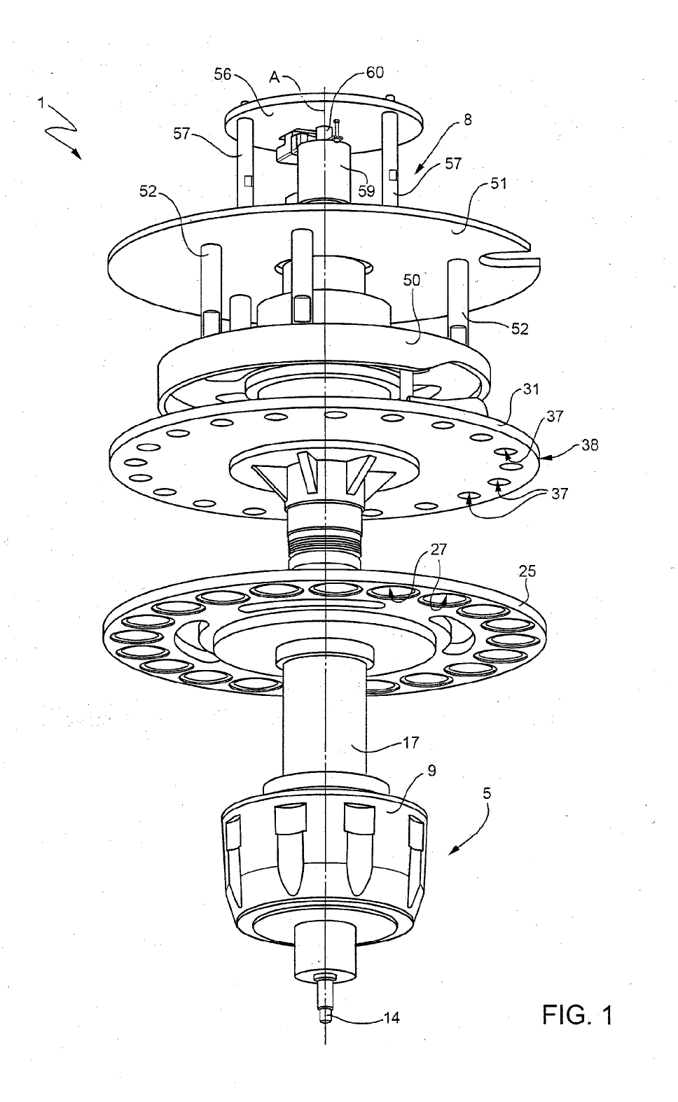

The present invention relates to a series of article-handling machines, one of which is indicated as a whole with number 1 in FIGS. 1 to 5.

In the following description, only one article-handling machine 1 of the series is described.

Article-handling machine 1 is adapted to process articles, in particular containers 4 such as glass bottles, plastic containers, cans and the like.

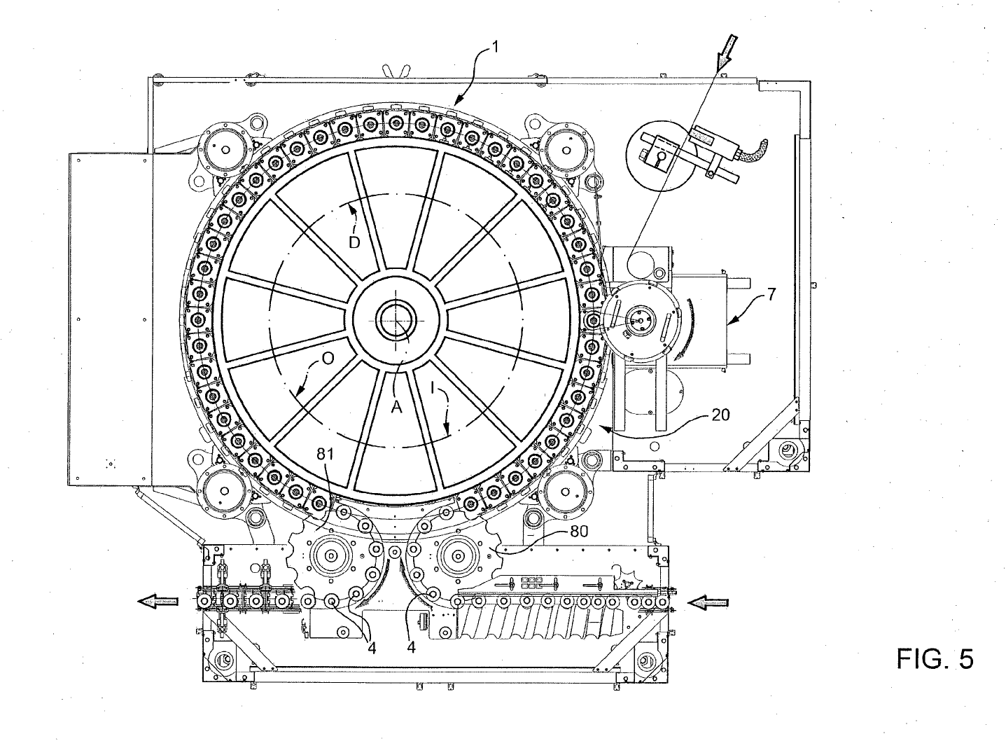

In particular, containers 4 (FIG. 5) are preferably made in plastic material, especially PET.

Containers 4 may be filled with a pourable product, especially with a pourable food product. Non-limiting examples of pourable food products are water, beer, sodas or fruits juices.

More precisely, number 1 in FIGS. 1 to 5 indicates a labelling machine for applying a plurality of labels (not shown) to respective containers 4.

Labelling machine 1 is adapted to be incorporated in a bottling plant (not shown) which substantially comprises a blowing station, a rinsing station, a filling station and a capping station all arranged upstream from labelling machine 1.

Very briefly, labelling machine 1 receives containers 4 to be labelled by an upstream star-wheel 80 and feeds labelled containers 4 to a downstream star-wheel 81 (FIG. 5).

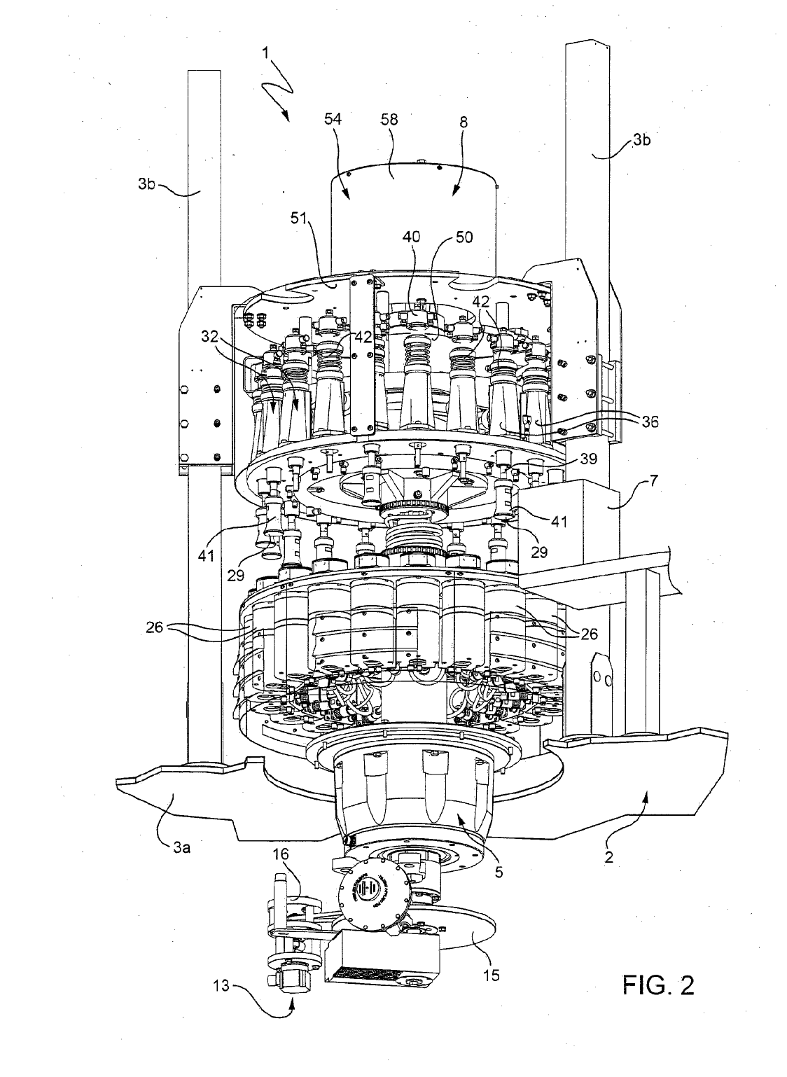

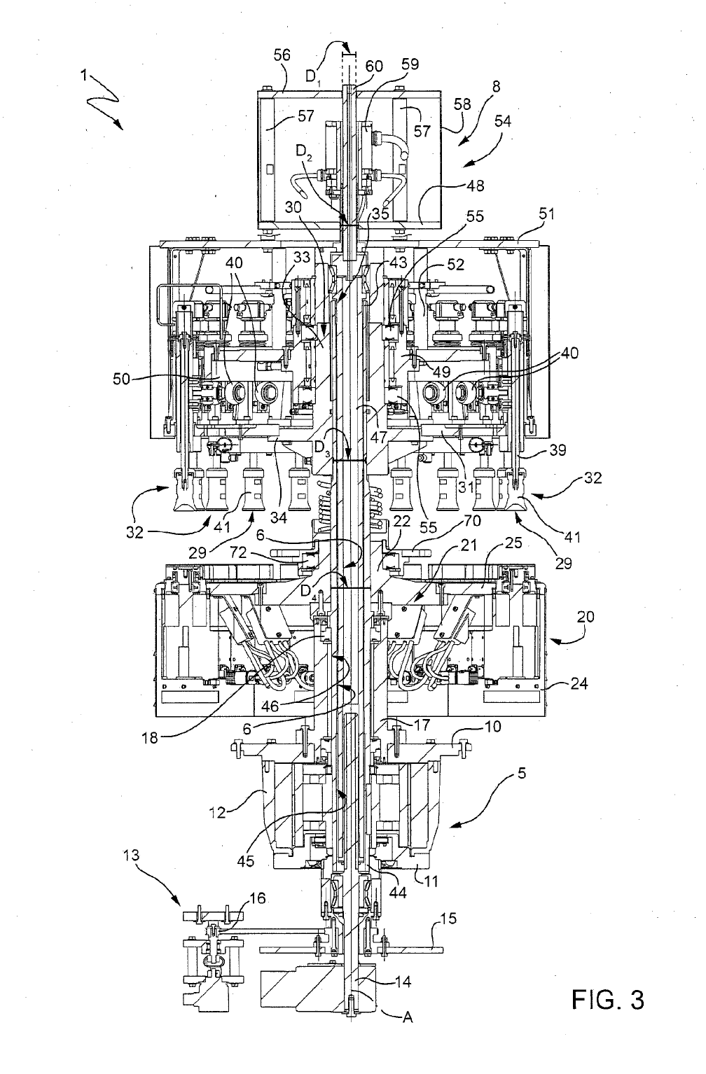

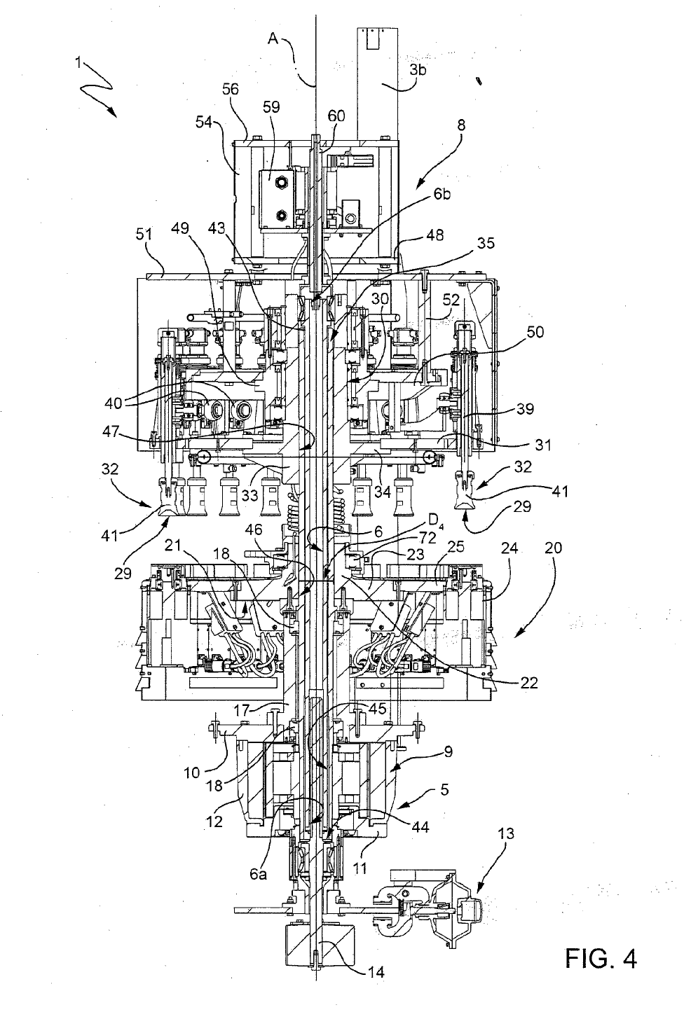

Each labelling machine 1 of the series substantially comprises:
a common base 2 (FIG. 2) which is fixed to the ground, and comprises a frame 3a and a plurality of vertical columns 3b upwardly protruding from frame 3;
a common motor 5 arranged at the bottom of machine 1;
a common hollow shaft 6 (FIGS. 3 and 4) which upwardly protrudes from motor 5 and rotates about an axis A, which is vertical in the embodiment shown;
a common labelling group 7 (only schematically shown in FIG. 5), which is fitted to base 2; and a common slip-ring 8 which is arranged substantially at the top of machine 1.

Shaft 6 substantially comprises a bottom end 6a and a top end 6b which is axially opposite to end 6a.

Labelling machine 1 also comprises a common shaft 35 which rotates about axis A integrally with shaft 6 and surrounds such a shaft 6.

In detail, shaft 35 comprises a top end 43 which is screwed to shaft 6 close to end 6b thereof, and a bottom end 44 which is axially opposite to end 43.

Motor 5 substantially comprises a casing 9 within which a bottom end 6a portion of shaft 6 is housed.

Casing 9 comprises, at its opposite axial ends, an upper flange 10 which is fixed to base 2 and a lower flange 11. Furthermore, casing 9 comprises an intermediate tubular body 12 which is connected to and axially interposed between flanges 10, 11.

Upper flange 10 is bolted to a stationary sleeve 17 which surrounds, through the interposition of axially-spaced bearings 18, a first intermediate portion 45. Intermediate portion 45 of shaft 35 which is arranged immediately above casing 9.

Labelling, machine 1 also comprises an encoder 13 for continuously reading the angular position of shaft 6 about axis A. More precisely, end 6b of shaft 6 houses and is angularly integral with a shaft 14 which downwardly protrudes from motor 5. Shaft 14 drives in rotation a first pulley 15 which is connected via a belt to a second pulley 16, the angular position of which is continuously indicated by encoder 13 (FIG. 1).

Each labelling machine 1 of the series advantageously comprises:
a carousel 20 for conveying a plurality of containers 4 along an arc-shaped path P which extends about axis A; and
an annular flange 21 which is angularly integral with carousel 20 and is fitted to a further intermediate portion 46 of shaft 35.

In particular, intermediate portion 46 is arranged above portion 45 of shaft 35.

Flange 21 comprises a top cylindrical portion 22 and a bottom end portion 23 which has a greater diameter than top cylindrical portion 22.

Carousel 20 comprises an annular top plate 25 and a hollow cylindrical cover 24 which protrudes downwardly from plate 25.

Bottom end portion 23 is radially interposed between intermediate portion 46 of shaft 35 and top plate 25 of carousel.

In particular, the outer radial edge of bottom end portion 23 is, connected, through a plurality of bolts in the embodiment shown, to inner radial edge of top plate 25 of carousel 20.

Carousel 20 also comprises a plurality of angularly spaced supporting elements 26 (FIG. 2) for supporting bottom ends of relative containers 4. Supporting elements 26 pass through relative seats 27 (FIG. 1) defined by the radially outer portion of plate 25.

With reference to FIG. 5, carousel 20 is fed by star-wheel 80 with containers 4 to be labelled at an inlet station I, conveys containers 4 along an arc-shaped path P which extends about axis A, and outputs labelled container 4 at an output station.

Labelling machine 1 also comprises:
a sleeve 30 arranged above flange 21 and angularly integral with a further intermediate portion 47 of shaft 35;
an annular wheel 31 angularly integral with sleeve 30; and
a plurality of angularly equi-spaced gripping elements 32 which are arranged above respective supporting elements 26 and driven in rotation by wheel 31 about axis A.

In detail, intermediate portion 47 is arranged above intermediate portion 46 of shaft 35. Furthermore, a radially outer diameter D₄ of intermediate portion 46 is greater than a radially outer diameter D₃ intermediate portion 47.

Sleeve 30 integrally comprises a main tubular body 33 which is fitted to portion 47 of shaft 35, and a ring 34 radially protruding from body 33 and connected, via a number of bolts in the embodiment shown, with the inner edge of wheel 31.

Furthermore, body 33 is fitted to shaft 35 through a splined coupling and is, therefore, angularly integral with shaft 6 about axis A.

Each gripping element 32 substantially comprises (FIGS. 1 and 2):
a casing 36;
a rod 39 which passes through a relative seat 37 arranged at the outer edge 38 of wheel 31;
a roller 40 which is arranged on an axial end of rod 39 and above wheel 31; and
a bell-shaped clamping element or gripper 41 defining an axial end 29 of rod 39 which is opposite to roller 40 and arranged below wheel 31.

Furthermore, each rod 39 may slide within casing 36 between a raised position in which end 29 is axially spaced from top end of relative container 4 and a lowered position in which end 29 cooperates with top end of relative container 4.

Each rod 39 is elastically loaded by a relative spring 42 (FIG. 2) towards the relative raised position.

As containers 4 move along arc-shaped path P, rods 39 are in the lowered position and ends 29 cooperate with top ends of containers 4 while supporting elements 26 support bottom ends of containers 4. Furthermore, labelling group 7 applies a label onto containers 4, as they are advanced by carousel 20 from inlet to outlet station I, O.

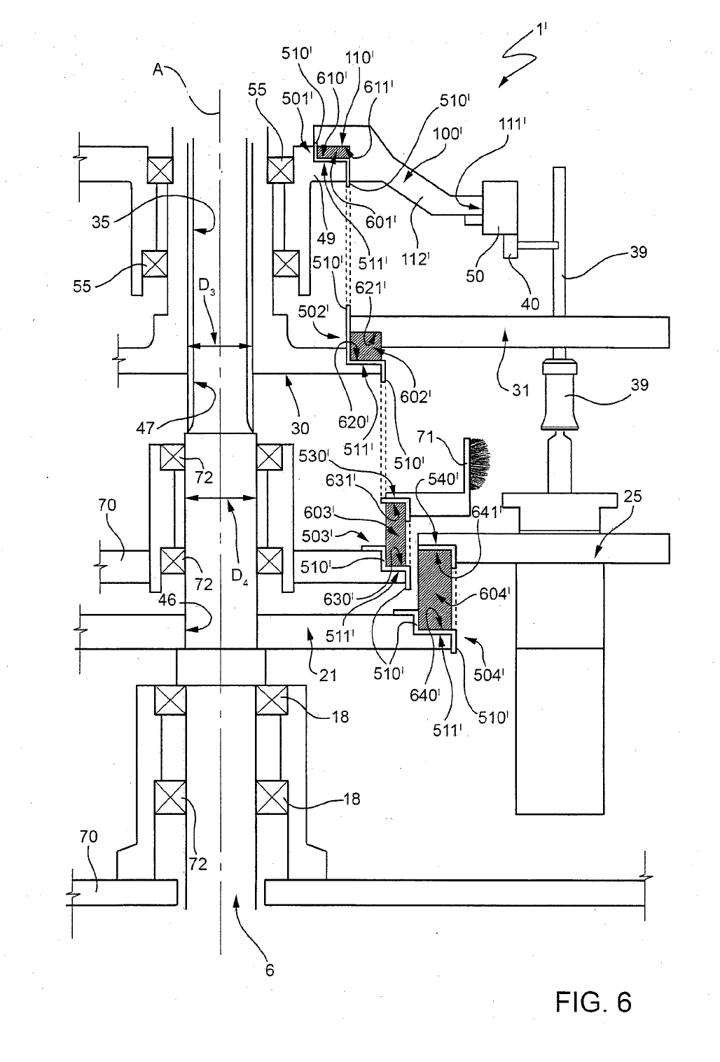

Labelling machine 1 also comprises a number of interconnected components which are stationary relative to axis A, namely:
a main cam 50 comprising a profile which is at least in part sloped relative to axis A and cooperates with rollers 40 to move relative rods 39 between relative raised and lowered positions;
an auxiliary cam 51 which is on the axial opposite side of wheel 31 relative to cam 50, and is connected to cam 50 through a number of vertical columns 52;
a tubular body 54 which houses slip-ring 8 and is connected to cam 51; and
a flange 70 (FIGS. 3 and 6) which is axially interposed between flange 21 and sleeve 30, and supports a brush ring 71 (shown only in FIG. 6) for wiping down label after attachment, in case of cold glue labelling.

In detail, bearings 72 are radially interposed between flange 70 and shaft 60.

In detail, cam 50 is connected, through a number of bolts in the embodiment shown, to a stationary flange 49, and a pair of axially-spaced bearings 55 are radially interposed between flange 49 and the portion of tubular body 33 which is on the opposite axial side of ring 34 relative to flange 21.

Tubular body 54 substantially comprises (FIG. 4):
a bottom flange 48 connected to cam 51 and, therefore, stationary relative to axis A;
a top flange 56 connected to flange 48 through a plurality of vertical columns 57; and
a cover 58 (FIG. 5) surrounding slip-ring 8 and axially extending between flanges 48, 56.

Slip ring 8 substantially comprises a hollow fixed part 59 fitted to flange 56 and a shaft 60 rotatable about axis A integrally with shaft 6.

In detail, shaft 60 passes with radial gap through flanges 48, 56 and wheel 31 and is coupled to end 6b of shaft 6.

More precisely, radially inner diameter D₁ of flange 56 is smaller than radially inner diameter D₂ of flange 48 (FIG. 3).

Furthermore, radially inner diameter D₂ of flange 48 is smaller than radially inner diameter D₃ of sleeve 30, which equals the radially outer diameter of intermediate portion 47 of shaft 35.

Accordingly, radially inner diameter D₃ of sleeve 30 is smaller than radially inner diameter D₄ of flange 21, which equals the radially outer diameter of intermediate portion 46 of shaft 35.

In use, carousel 20 receives containers 4 to be labelled from star-wheel 80 at the inlet station I, advances containers 4 along path P and feeds star-wheel 81 with labelled containers 4 at the outlet station O.

Cam 50 interacts with rollers 40 to set relative rods 39 in the lowered position at the inlet station, to keep relative rods 39 in the lowered position along path P, and to move relative rods 39 towards the raised position at the outlet station.

In this way, supporting elements 26 support bottom ends of relative containers 4 and ends 29 cooperate with top end of these containers 4.

Labelling group 7 applies labels to relative containers 4 which advance along path P.

In case it is necessary to vary the diameter of carousel 20 and/or the pitch between supporting elements 26, the following operation must be carried out:
removal of flange 56, 48 and slip-ring 8;
removal of cams 50, 51 from columns 3b;
removal of sleeve 30 and of wheel 31 from shafts 35, 6; and
removal of carousel 20 and of flange 21 from shafts 35, 6.

At this stage, a new carousel 20 and flange 21 are chosen on the basis of the needed throughput of labelling machine 1. More precisely, for each throughput of the labelling machine 1, a carousel 20 with a given diameter and a given pitch between supporting elements 25 is necessary.

It goes without saying that also a new sleeve 30, a new corresponding wheel 31 and a new cams 50, 51 are chosen on the basis of the new diameter of carousel 20 and of the new pitch between supporting elements 25.

New flange 21 is mounted together with new carousel 20 onto intermediate portion 46 of same shaft 35, and new sleeve 30 is mounted together with new wheel 31 onto intermediate portion 47 same shaft 35.

At this stage, a new cam 50 is mounted onto the new sleeve 30 and fixed to columns 4.

In this way, a series of labelling machines 1 may be obtained, all having the same common shafts 6, 35 and different carousel 20, wheel 31 and cams 50.

Number 1′ in FIG. 6 indicates a second embodiment of a article-handling machine in accordance with the present invention; article-handling machine 1, 1′ being similar to each other, the following description is limited to the differences between them, and using the same references, where possible, for identical or corresponding parts.

In particular, article-handling machine 1′ differs from article-handling machine 1 in that top plate 25 is no longer directly bolted to flange 21 and in that wheel 31 is no longer directly bolted to sleeve 30.

Furthermore, article-handling machine 1′ comprises an arm 100′ which is interposed between flange 49 and cam 50.

Arm 100′ comprises a radial inner end 110′ connected to flange 49, a radially outer end 111′ connected to cam 50, and an intermediate main portion 112′ interposed between ends 110′, 111′ and sloped relative to axis A.

Article-handling machine 1′ also comprises:
a first radial interface 501′ and a first axial interface 601′ which are releasably connected to each other and interposed between flange 49 and arm 100′;
a second radial interface 502′ and a second axial interface 602′ which are releasably connected to each other and interposed between sleeve 30 and wheel 31;
a third radial interface 503′ and a third axial interface 603′ which are releasably connected to each other and interposed between a flange 70 and a brush ring 71; and
a fourth radial interface 504′ and a fourth axial interface 604′ which are connected to each other and interposed between flange 21 and plate 25.

Each interface 501′, 502′, 503′, 504′ comprises two vertical portions 510′ opposite to each other and a horizontal portion 511′ interposed between portions 510′.

Interface 601′ comprises a bottom end 610′ releasably connected to portion 511′ of interface 501′, and a top end 611′, opposite to bottom end 610′, connected to end 110′ of arm 100′.

In this way, interfaces 501′, 601′ allow to vary respectively the radial and the axial position of arm 100′, and therefore, of cam 50, rollers 40 and rods 39 relative to flange 49.

Interface 602′ comprises a bottom end 620′ connected to portion 511′ of interface 502′, and a top end 621′, opposite to bottom end 620′, connected to wheel 31.

In this way, interfaces 502′, 602′ allow to vary respectively the radial and the axial position of wheel 31, and therefore, of clamping elements 41 relative to sleeve 30.

Interface 603′ comprises:
a bottom end 630′ connected to portion 511′ of interface 503′; and
a top end 631′, opposite to bottom end 630′, connected to brush ring 71 through the interposition of a further radial interface 530′.

In this way, interfaces 503′, 603′, 530′ allow to vary respectively the radial and the axial position of brush ring 71 relative to flange 70.

Interface 604′ comprises:
a bottom end 640′ connected to portion 511′ of interface 504′; and
a top end 641′, opposite to bottom end 540′, connected to plate 25, through the interposition of a further radial interface 540′.

In this way, interfaces 504′, 604′, 540′ allow to vary respectively the radial and the axial position of plate 25, and therefore of carousel 20, relative to flange 21.

In particular, the radial position of arm 100′ and wheel 31 relative respectively to flange 49, sleeve 30, may be varied by conveniently design the radial extension of portions 511′ of interfaces 501′, 502′.

In the very same way, the radial position of brush ring 71 (plate 25) relative to flange 70 (flange 21) may be varied by adequately designing the radial extension of portions 511′ of interface 503′ (504′) and the radial extension of interfaces 530′, (540′).

The axial position of arm 100′, wheel 31, brush ring 71 and plate 25 relative respectively to flange 49, sleeve 30, flange 70 and flange 21 may be varied by conveniently design the axial height of interfaces 601′, 602′, 603′, 604′.

From an analysis of the features of the series of article-handling machines 1, 1′ according to the present invention, the advantages it allows to obtain are apparent.

In particular, labelling machines 1, 1′ of the series according to the invention comprises the same common shafts 6, 35 whereas each labelling machine has a specific flange 21 and a specific sleeve 30 releasably connected to common shafts 35, 6.

Accordingly, in case that the throughput of labelling machine 1, 1′ calls for a different diameter of carousel 20 and for a different pitch between supporting elements 26 and gripping elements 32, it is no longer necessary completely re-design the labelling machine 1 with an evident reduction of the costs and the number of items involved.

As a matter of fact, the existing flange 21 together with carousel 20 and the existing sleeve 30 together with wheel 31 are removed from the common shaft 35. Subsequently, a new flange 21 together with a new carousel 20 and a new sleeve 30 together with a new wheel 31 are fitted to the shaft 6. The diameter at which supporting and gripping elements 26, 32 of new carousel 20 and new sleeve 30 are arranged allows the processing of the new size and format of containers 4. Analogously, the pitch between new supporting and new gripping elements 26, 32 of new carousel 20 and new sleeve 30 are arranged allows the processing of the new size and format of containers 4.

In order to control the newly arranged gripping elements 32, a new flange 49 with a new cam 50 is coupled with new sleeve 30.

Furthermore, labelling machine 1, 1′ comprises, form the top to the bottom, flanges 56, 48, sleeve 30 and flange 21 which have increasing inner radial diameter D₁, D₂, D₃, D₄.

Therefore, the mounting of new flange 21 on the common shafts 35, 6 does not prevent the mounting of the new sleeve 30 on the same common shaft 35, 6.

In the very same way, the mounting of new sleeve 30 on the common shaft 6 does not prevent the mounting of the new flange 48 on the same common shafts 35, 6.

The mounting of new flange 48 on the common shafts 6, 35 does not prevent the mounting of the new flange 56 on the same common shafts 35, 6.

Article-handling machines 1′ are particularly advantageous since the radial and the axial position of new carousel 20 relative to new flange 21 and of new wheel 31 relative to new sleeve 30 may be varied by using respectively interfaces 504′, 604′, 540′; 502′, 602′.

Furthermore, the radial and axial position of cam 50 relative to flange 49 may be varied by using respectively interface 501′, 601′. In the very same way, the radial and the axial position of the new ring brush 71 relative to flange 70 may be varied by using interfaces 503′, 530′; 603′.

Finally, it is apparent that modifications and variants not departing from the scope of protection of the claims may be made to series of labelling machines 1, 1′.

In particular, labelling machine 1, 1′ could comprise, form the top to the bottom, flanges 56, 48, sleeve 30 and flange 21 which have decreasing inner radial diameter D₁, D₂, D₃, D₄.

1. A series of article-handling machines, comprising:
a common first rotating element rotatable about an axis;
wherein each article-handling machine comprises:
a carousel for conveying a plurality of articles along a path; and
a first connecting element which is angularly integral with said carousel and is releasably connected to said common first rotating element.

2. Series of article-handling machines according to claim 1, wherein each said article-handling machine comprises:
a wheel carrying a plurality of elements which are each movable between a relative rest position in which it is axially detached from relative said article and a relative operative position in which it cooperates with relative said article; and
a second connecting element which is angularly integral with said wheel and is releasably connected to said common first rotating element

3. Series of article-handling machines according to claim 1, comprising a common shaft surrounding and angularly integral with said first rotating element;
said common shaft comprising:
a first portion to which said second connecting member of each article-handling machine is fitted;
a second portion to which said first connecting member of each article-handling machine is fitted;
a first outer diameter of said second portion being larger than a second outer diameter of said first portion

4. Series of article-handling machines claim 1, wherein said first connecting element of each article-handling machine is arranged, in use, below relative said second connecting element;
the inner diameter of said first connecting element being larger than the inner diameter of said second connecting element

5. Series of article-handling machines according to claim 1, wherein each said article handling machine comprises a slip-ring assembly;
said slip-ring assembly comprising:
a second and a third flange which are stationary relative to said axis;
a second rotating element which is connected to said common first rotating element;
said second flange being axially interposed between said third flange and said second connecting element;
a first inner diameter of said third flange being smaller than a second inner diameter of said second flange;
said second inner diameter being smaller than said second outer diameter

6. Series of article-handling machine according to claim 1, comprising a common shaft surrounding and angularly integral with said common first rotating element;
said common shaft comprising:
a first portion to which said second connecting member of each article-handling machine is fitted;
a second portion to which said first connecting member of each article-handling machine is fitted;
a first outer diameter of said second portion being smaller than a second outer diameter of said first portion;
said first connecting element being arranged, in use, below said second connecting element;
each said article-handling machine comprising a slip-ring assembly which, in turn, comprises:
a second and a third flange which are stationary relative to said axis;
a second rotating element which is connected to said common first rotating element;
said second flange being axially interposed between said third flange and said second connecting element;
a first inner diameter of said third flange being larger than a second inner diameter of said second flange;
said second inner diameter being larger than said second outer diameter

7. Series of article-handling machines claim 1, wherein each said article-handling machine comprises:
a fourth flange stationary relative to said axis and relative to which said second connecting element is rotable about said axis; and
a cam fitted to said fourth flange and which interact, in use, with a plurality of rollers carried by relative elements for moving them between relative rest and operative positions

8. Series of article-handling machines claim 1, wherein each said article-handling machine comprises:
a first interface releasably connected to said first connecting element and having a first connecting surface arranged at a desired radial distance from said axis; and
a second interface releasably connected to said first connecting surface of said first interface and to said carousel;
said second interface arranging, in use, at a desired axial distance said carousel and said first connecting element.

9. Series of article-handling machines claim 1, wherein each said article-handling machine comprises:
a third interface releasably connected to said second connecting element and having a second connecting surface arranged at a desired radial distance from said axis; and
a fourth interface releasably connected to said second connecting surface of said third interface and to said wheel;
said fourth interface arranging, in use, at a desired axial distance said second connecting element and said wheel.

10. Series of article-handling machines claim 1, wherein each said article-handling machine comprises:
a fifth interface releasably connected to said fourth flange and having a third connecting surface arranged at a desired radial distance from said axis; and
a sixth interface releasably connected to said third connecting surface of said fifth interface and to said cam;
said sixth interface arranging, in use, at a desired axial distance said flange and said cam.

11. Series of article-handling machines claim 1, wherein each said article-handling machine is a labelling machine for applying a plurality of labels onto relative articles

12. Series of article-handling machines, according to claim 1, wherein each said labelling machine comprises:
a third connecting element which is stationary relative said axis, relative to which said common first rotating element is rotable about said axis, and is axially interposed between said first and second connecting elements;
a brush ring which is supported by said third connecting element and is adapted to wipe down labels after their application onto relative said articles

13. Series of article-handling machines claim 1, wherein each said labelling machine comprises:
a seventh interface releasably connected to said third connecting element and having a connecting surface arranged at a desired radial distance from said axis; and
an eight interface releasably connected to said connecting surface of said seventh interface and to said brush ring;
said seventh interface arranging, in use, at a desired axial distance said bush ring and said third connecting element

14. Article-handling machine, comprising:
a rotating element is rotable about an axis; and
a carousel for conveying a plurality of said articles along a path;
comprising a connecting element which is angularly integral with said carousel and is releasably connected to said rotating element.
